(19) United States
(12) Patent Application Publication
(10) Pub. No.: US 2022/0136309 A1
(43) Pub. Date: May 5, 2022

(54) COUNTERBALANCE MECHANISM WITH MOVABLE PLATE

(71) Applicant: MAGNA CLOSURES INC., Newmarket (CA)

(72) Inventor: Mario Cappelli, Newmarket (CA)

(21) Appl. No.: 17/409,073

(22) Filed: Aug. 23, 2021

Related U.S. Application Data
(60) Provisional application No. 63/107,218, filed on Oct. 29, 2020.

(51) Int. Cl. E05F 15/622; B60J 5/10

(52) U.S. Cl. CPC E05F 15/622; B60J 5/106; E05Y 2201/434; E05Y 2201/474; E05Y 2900/546; E05Y 2201/702; E05Y 2400/354; E05Y 2400/40; E05Y 2400/44; E05Y 2201/70

(57) ABSTRACT

A counterbalance mechanism for assisting in opening and closing of a closure panel of a vehicle between a closed position and an open position, the counterbalance mechanism including: a housing for mounting a biasing mechanism of the counterbalance mechanism between the body and the closure panel; the biasing mechanism including: a fixed primary abutment of the housing having a primary biasing element mounted thereon; a fixed secondary abutment of the housing having a secondary biasing element mounted thereon; a movable plate variably positioned on a bias axis, the moveable plate between the primary biasing element and the secondary biasing element, an axial position of the movable plate movable in relation to the fixed primary abutment and the fixed secondary abutment to selectively change a primary spring constant of the primary biasing element and a secondary spring constant of the secondary biasing element; and an actuator connected to the movable plate, the actuator responsive to a control signal in order to adjust the position of the movable plate; wherein the primary biasing element applies a spring force to moderate extension of the counterbalance mechanism affecting movement of the closure panel between the open and closed positions.

### CROSS-REFERENCE TO RELATED APPLICATIONS

The present application claims the benefit of previously filed U.S. Provisional Patent Application No. 63/107,218 entitled “COUNTERBALANCE MECHANISM WITH MOVABLE PLATE”, filed Oct. 29, 2020, the contents of which are hereby incorporated by reference in its entirety herein.

### FIELD

This disclosure relates to a counterbalance mechanism for a closure panel.

### BACKGROUND

Some vehicles are equipped with a closure panel, such as a lift gate, which is driven between an open position (position 2) and a closed position (position 1) using an electric drive system. Disadvantages of current electric drive systems include bulky form factors which take up valuable vehicle cargo space, for example occupying space along the vertical supports delimiting the opening of a rear lift gate, tending to limit the size of access through the opening and into the interior cargo space), requirement to have additional lift support systems in tandem such as gas struts and other counterbalance mechanisms, unacceptable impact on manual open and close efforts requiring larger operator applied manual force at the panel handle, and/or temperature effects resulting in variable manual efforts required by the operator due to fluctuations in ambient temperature. Further, cost of spring assisted spindle designs can depend upon the size of motor used to assist in actuation of the spindle, as well as the length of a power screw operated by the motor. It is desired to have a spindle system that provides for a reduced motor size and/or a reduction in the length of the power screw.

It is recognized that ideally in an automotive lift gate, the gate could be balanced (self holding) at a number (e.g. all) opening angle configurations. Traditional strut type systems use springs and internal friction devices to the hold the gate, however these traditional systems suffer from inconsistent opening/closing forces applied to the lift gate during its operation, especially due to changes in orientation of the closure panel during operation thereof. Additionally, when the vehicle is parked on an incline, the torque required to hold the gate open changes as compared to a horizontal vehicle orientation.

### SUMMARY

It is an object of the present invention to provide a counterbalance mechanism that obviates or mitigates at least one of the above presented disadvantages.

One aspect provided is a counterbalance mechanism for assisting in opening and closing of a closure panel of a vehicle between a closed position and an open position, the counterbalance mechanism including: a housing for mounting a biasing mechanism of the counterbalance mechanism between the body and the closure panel; the biasing mechanism including: a fixed primary abutment of the housing having a primary biasing element mounted thereon; a fixed secondary abutment of the housing having a secondary biasing element mounted thereon; a movable element variably positioned on a bias axis, the moveable element between the primary biasing element and the secondary biasing element, an axial position of the movable element movable in relation to the fixed primary abutment and the fixed secondary abutment to selectively change a primary bias of the primary biasing element and a secondary bias of the secondary biasing element; and an actuator connected to the movable element, the actuator responsive to a control signal in order to adjust the position of the movable element; wherein the primary biasing element applies a spring force to moderate extension of the counterbalance mechanism affecting movement of the closure panel between the open and closed positions.

A further aspect provided is a method of operating a counterbalance mechanism having a primary biasing element and a secondary biasing element by moving a moveable element between a fixed primary abutment and a fixed secondary abutment of the counterbalance mechanism in order to vary a primary spring constant of the primary biasing element and a secondary spring constant of the secondary biasing element.

In another aspect there is provided a counterbalance strut or spindle provided with a biasing mechanism.

In another aspect there is provided a method of actively adjusting the counterbalance force of a counterbalance mechanism in response to the sensed changed in inclination of the vehicle relative to a level plane, to counteract the change in torque load applied by the closure panel on the counterbalance due to the change in inclination of the vehicle.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a perspective view of a vehicle with a liftgate supported by one or more counterbalance struts;

FIG. 2 is a cross-section view of a counterbalance strut in accordance with an illustrative embodiment;

FIG. 3a is a cross sectional view of a strut as is known in the art;

FIG. 3b is a cross sectional view of operational modes of the counterbalance mechanism of FIG. 2;

FIG. 4 show an example change in the biasing force of the primary biasing element of the counterbalance mechanism of FIG. 2;

FIGS. 5a and 5b show example graphs for operation of an example closure panel of the vehicle of FIG. 1;

FIG. 6 shows an example graph for spring constant of the operation of the closure panel of FIG. 2;

FIG. 7 shows an example kinematic diagram for operation of the counterbalance mechanism of FIG. 2; and

FIG. 8 is a flow chart of a control operation for varying the spring rate affecting the counterbalance torque output of a counterbalance mechanism of FIG. 2 to compensate for changes in inclination of a vehicle altering the closure panel torque profile.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

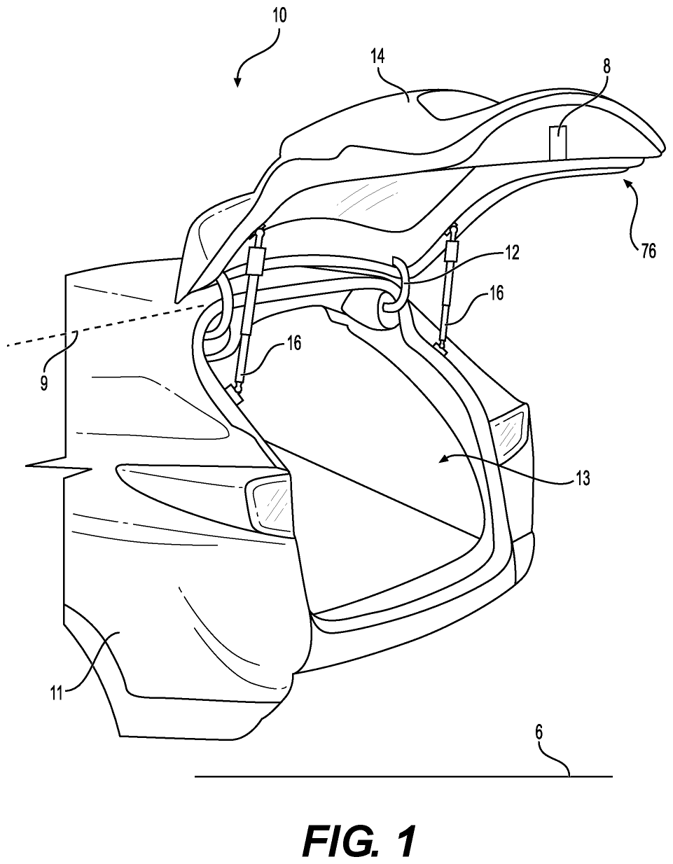

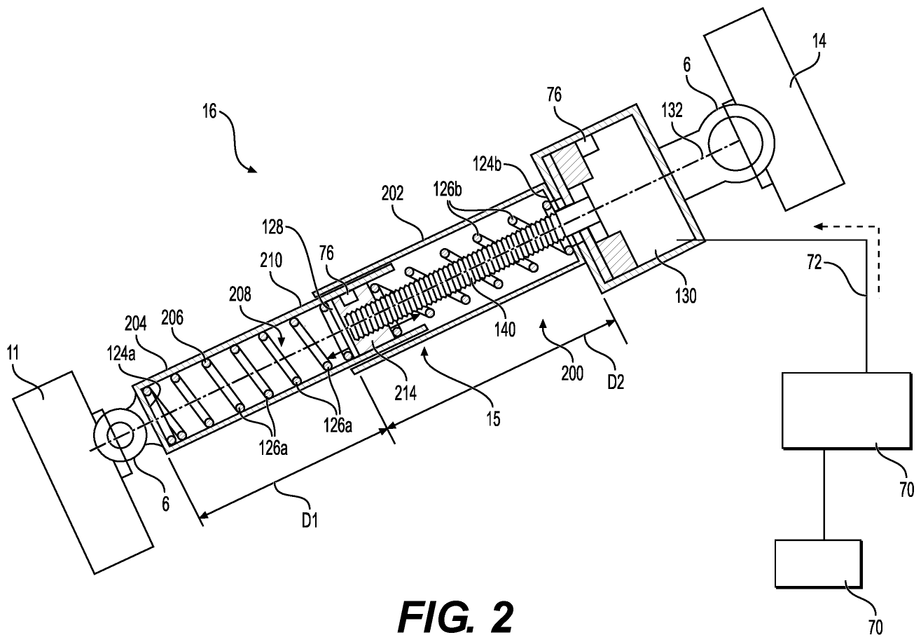

Referring to FIGS. 1 and 2, provided is a counterbalance mechanism 16 (e.g. configured using a biasing mechanism 15) that can be used advantageously with vehicle closure panels 14 to provide for counterbalanced open and close operations for the closure panel(s) 14 of vehicles 10, as the vehicle is positioned/supported on a ground surface 6. Other applications of the counterbalance mechanism 16, in general for closure panels 14 both in and outside of vehicle applications, include advantageously assisting in optimization of overall hold and manual effort forces for closure panel 14 operation. It is recognized as well that the counterbalance mechanism 16 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). The closure panel 14 can be connected to a body 11 of the vehicle 10 by hinges 12 for pivoting about a hinge axis 9. Assistance in pivoting about the hinge axis 9 is provided by the one or more counterbalance mechanism 16 (otherwise referred to as spindles or struts, as desired).

As shown, the counterbalance mechanism 16 can include a biasing mechanism 15 (see FIG. 2). In particular, the biasing mechanism 15 can be spring assisted (see biasing elements 126a,b) and used to provide or otherwise assist in a holding force (or torque) for the closure panel 14. Further, it is recognized that the counterbalance mechanism 16 is configured as a component of a closure panel 14 assembly, as further described below. The biasing mechanism 15 of the counterbalance mechanism 16 can be of an electromechanical type (e.g. driven by an integrated motor assembly with spring supplying a bias), as desired.

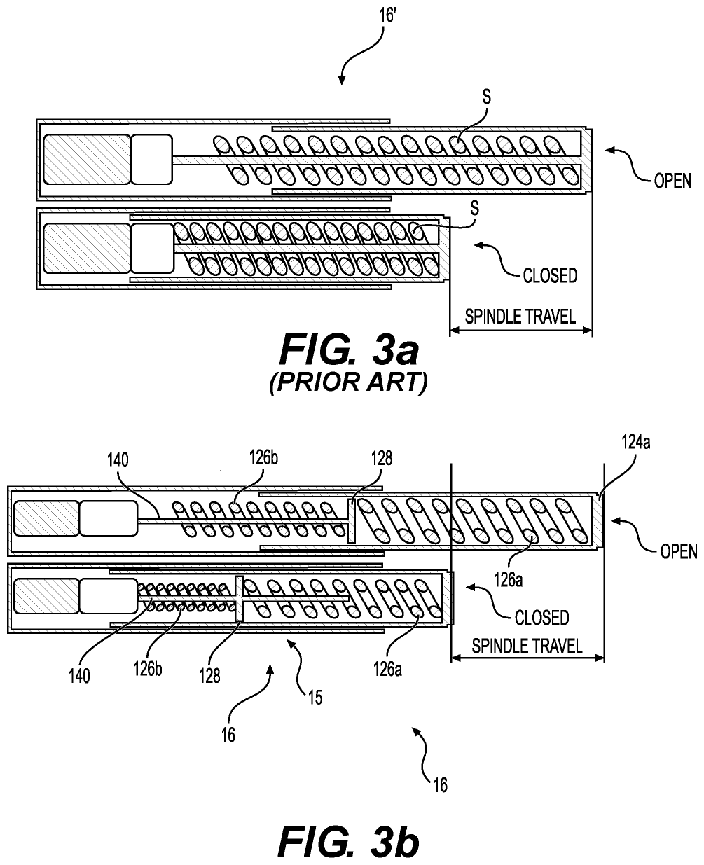

The counterbalance mechanism 16 is coupled to the closure panel 14 and to a body 11 of the vehicle 10. The closure panel 14 is operated between and open position (shown in FIG. 1) and a closed position (shown conceptually in FIG. 3b). For vehicles 10, the closure panel 14 can be referred to as a partition or door, typically hinged, but sometimes attached by other mechanisms such as tracks, in front of an opening 13 which is used for entering and exiting the vehicle 10 interior by people and/or cargo. It is also recognized that the closure panel 14 can be used as an access panel for vehicle 10 systems such as engine compartments and also for traditional trunk compartments of automotive type vehicles 10. The closure panel 14 can be opened to provide access to the opening 13, or closed to secure or otherwise restrict access to the opening 13, as maintained in the closed position via a latch 8 as is known in the art.

It is also recognized that there can be one or more intermediate hold positions of the closure panel 14 between a fully open position and fully closed position, as assisted at least in part by the counterbalance mechanism 16. For example, the counterbalance mechanism 16 can assist in biasing movement of the closure panel 14 away from one or more intermediate hold position(s), also known as Third Position Hold(s) (TPHs) or Stop-N-Hold(s), once positioned therein. It is also recognized that the counterbalance mechanism 16 can be provided as a component of the closure panel 14 assembly, or separate thereto, as desired.

The closure panel 14 can be opened manually and/or powered electronically via the counterbalance mechanism 16, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14. The force assisted open and close mechanism(s) can be provided by the counterbalance mechanism 16, any biasing members external to the counterbalance mechanism 16 (e.g. spring loaded hinges, spring loaded struts, gas loaded struts, electromechanical struts, etc.) when used as part of the closure panel 14 assembly.

Illustratively, referring to FIG. 2, the actuator (e.g. motor) 130 is controlled by one or more controller(s) 70 (e.g. body control module) in electrical communication therewith via control signals 72 (e.g. on, off, reverse, forward) for issuing pulse width modulated control signals 72 for controlling rotational direction of the actuator 130, speed of the actuator 130, stopping of the actuator 130 for obstacle detection (or otherwise reaching end of travel for the closure panel 14—e.g. defined open/close/hold position), and other functionalities for controlling the movement of the closure panel 14. The controller 70 can draw power from a source of electric energy, such as the vehicle main battery (not shown). Further, the body 11 and/or closure panel 14 and/or actuator 130 and/or biasing mechanism 15 can have mounted thereon one or more sensors 76 (e.g. position sensors). Positions sensors 76 can provide data regarding the extension and retraction of the counterbalance mechanism 16, and for example the relative movement between the outer tubular wall 210 e.g. a first tube and the stationary guide tube 202 e.g. a second tube, where first and second tubes are extendable and retractable relative to one another for example in an overlapping relationship. Other position sensors may be provided, for example on the hinge(s) 12 to determine the angle of opening of the closure panel 14, from which the extension or retraction travel of the counterbalance mechanism 16 can be determined. As further described below, the actuator 130 is used to vary an axial position of the moveable plate 128 along a bias axis 132, based in part on signals received from the sensor(s) 76 by the controller 70.

For example, a panel angle position sensor 76 (e.g. accelerometer) can be located on the closure panel 14 and provide active angle position feedback signals via the control signals 72 to the controller 70. During an opening/closing sequence of the closure panel 14, the biasing mechanism 15 can provide the required torque to lift the closure panel 14 through feedback from the angle sensor 76 and actuator 130 operation resulting in adjustment of the position of the moving plate 128 on the bias axis 132 (see FIG. 2). If the position sensor(s) 76 sense(s) an angle change as a result of a manual input (e.g. via the vehicle user), the actuator 130 can be powered to provide the required change in spring force (of the biasing elements 126a,b) to adjust the closure panel 14 movement/location. If the vehicle 10 is parked on an incline (i.e. the ground surface 6 is other than horizontal), the feedback from the angle sensor 76 can provide the controller 70 with the incline information required to compensate for changes in the magnitude/angle of weight experienced by the biasing mechanism 15 and thus compensate therefore via positioning of the moving plate 128 (also referred to as moveable element 128) in order to position (e.g. hold, open, close) the closure panel 14 accordingly. As discussed below, the biasing mechanism 15 uses the actuator 130 (e.g. gear motor) to vary the spring force applied to the closure panel 14 via the counterbalance mechanism 16. The actuator 130 can drive the movable plate 128 (e.g. via an acme lead screw 140) to increase or decrease the spring force, as further described below.

Referring again to FIG. 2, the counterbalance mechanism 16 incorporates the biasing mechanism 15 having fixed abutments 124a,b of a housing 200, upon which the biasing elements 126a,b (e.g. compression/extension springs) are mounted. For example, primary biasing element 126a is mounted to primary abutment 124a, while secondary biasing element 126b is mounted to secondary abutment 124b. Also mounted to the housing 200 is the actuator 130 (e.g. electrical motor), which is used to change the axial position of the movable plate 128 along the bias axis 132. As shown, the movable plate 128 is positioned on the bias axis 132 between the primary biasing element 126a and the secondary biasing element 126b, such that the primary biasing element 126a extends along the biasing axis 132 between the primary abutment 124a and the moveable plate 128 and the secondary biasing element 126b extends along the biasing axis 132 between the moveable plate 128 and the secondary abutment 124b. As shown, the position of the moveable plate 128 (along the bias axis 132) will affect the length and thus the spring constant of the biasing elements 126a,b.

Referring to FIG. 2, there is illustratively shown an embodiment of the biasing mechanism 15 provided in a counterbalance mechanism (e.g. strut) 16 for assisting in opening and closing of a hinged closure panel 14 of a vehicle 10 between a closed position and an open position (see FIG. 1). The counterbalance strut 16 includes the housing 200 connected to one of the Closure panel (e.g. lift gate) 14 and the vehicle body 11, the housing 200 including a stationary guide tube 202. The counterbalance strut 16 further includes an extensible member 204 slidably mounted to the housing 200 and connected to the other of the lift gate 14 and the vehicle body 11, the extensible member 204 including a tubular wall 206 defining a radially interior chamber 208, the stationary guide tube 202 extending into the radially inner interior chamber 208 adjacent the tubular wall 206 of the extensible member 204. Alternatively stationary guide tube 202 may extend around the tubular wall 206 of the extensible member 204 adjacent the outer tubular wall 210 of the extensible member 204. The extensible member 204 includes the fixed abutments 124a,b having the respective biasing elements 126a,b (primary biasing element 126a and secondary biasing element 126b) mounted thereon. In the embodiment illustrated in FIG. 2, the biasing primary element 126a includes at least one coil spring disposed within the interior chamber 208 and coupled between one end (i.e. primary abutment 124a) of the extensible member 204 and the movable plate 128 for providing a mechanical counterbalance to the weight of the lift gate 14, and a rotatable lead (e.g. power) screw 140 extending into the interior chamber 208 of the extensible member 204.

The counterbalance strut 16 further includes a drive nut 214 (mounted to the moveable plate 128) mounted in the interior chamber 208 of the extensible member 204, the drive nut 214 threadingly engaging the lead screw 140, the drive nut 214 further coupled to the secondary biasing element 126b, the drive nut 214 movable in relation to the fixed abutments 124a,b to move the moveable plate 128 to selectively change the respective spring constants of the biasing elements 126a,b. The counterbalance strut 16 further includes the actuator 130 connected to the rotatable lead screw 140, the actuator 130 responsive to one or more control signals 72 in order to adjust a position of the drive nut 214 (and thus the attached moveable plate 128) in relation to the fixed abutments 124a,b in order to selectively change the spring constant of the primary/secondary biasing elements 126a,b, wherein the primary biasing element 126a applies a spring force to moderate linear movement of the extensible member 204 affecting movement of the closure panel 14 between the open and closed positions. The housing 200 can be connected at one end to the closure panel 14 by a pivot 6 (e.g. ball joint) and connected at the other end by another pivot 6 (e.g. ball joint).

For example, moving the moveable plate 128 towards the primary abutment 124a will act to decrease the length of the primary biasing element 126a (for a fixed open/close position of the closure panel 14) and thus increase the spring constant of the primary biasing element 126a. Further, moving the moveable plate 128 towards the primary abutment 124a can act to maintain the length of the primary biasing element 126a (as the closure panel 14 moves towards an open position as the counterbalance mechanism 16 extends—e.g. the primary abutment 124a and the secondary abutment 124b move away from one another on the bias axis 132) and thus maintain the spring constant of the primary biasing element 126a. Further, moving the moveable plate 128 away from the primary abutment 124a can act to maintain the length of the primary biasing element 126a (as the closure panel 14 moves towards a closed position as the counterbalance mechanism 16 retracts—e.g. the primary abutment 124a and the secondary abutment 124b move towards one another on the bias axis 132) and thus maintain the spring constant of the primary biasing element 126a.

It is envisioned that further operational examples of the moveable plate 128 can be provided, such as but not limited to: actively increase the length of the primary biasing element 126a as the primary abutment 124a and the secondary abutment 124b move away from one another on the bias axis 132; actively increase the length of the primary biasing element 126a as the primary abutment 124a and the secondary abutment 124b move towards one another on the bias axis 132; actively decrease the length of the primary biasing element 126a as the primary abutment 124a and the secondary abutment 124b move away from one another on the bias axis 132; and/or actively decrease the length of the primary biasing element 126a as the primary abutment 124a and the secondary abutment 124b move towards one another on the bias axis 132. It is recognized that in general, an increase or a decrease in the length of the primary biasing element 126a (or the secondary biasing element 126b for that matter) would cause a respective corresponding increase or decrease in the spring constant of the primary biasing element 126a (or the secondary biasing element 126b for that matter). As envisioned, the increasing, decreasing, or maintaining of the length of the primary biasing element 126a (via the variable positioning of the moveable plate 128 in view of operation of the actuator 130 and lead screw 140) can be performed during: 1) an open operation of the closure panel 14, a close operation of the closure panel 14; and/or a hold position of the closure panel 14.

Further, it is recognized that the secondary biasing element 126b is positioned between the moving plate 128 (e.g. in contact with the drive nut 214) and the secondary abutment 124b of the housing 200. As the moveable plate 128 is displaced along the bias axis 132, the spring constant of the secondary biasing element 126b is varied as its length between the moveable plate 128 and the secondary abutment 124b is also varied. It is recognized that the biasing (e.g. spring) force of the secondary biasing element 126b can be used by the counterbalance mechanism 16 to assist the actuator 130 in moving the movable plate 128 along the bias axis 132, recognizing that the primary biasing element 126a can provide resistance to the movable plate 128 travelling towards the primary abutment 124a.

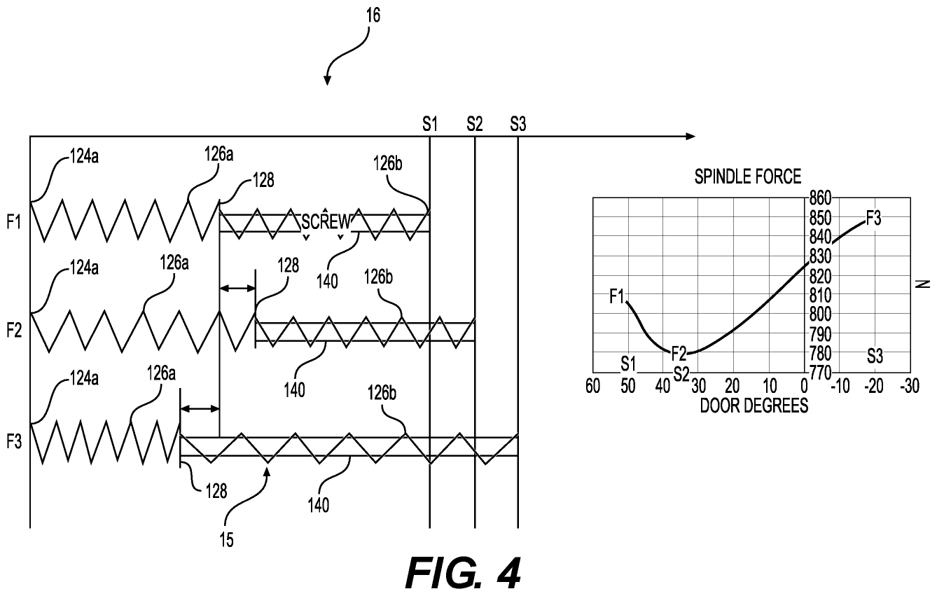

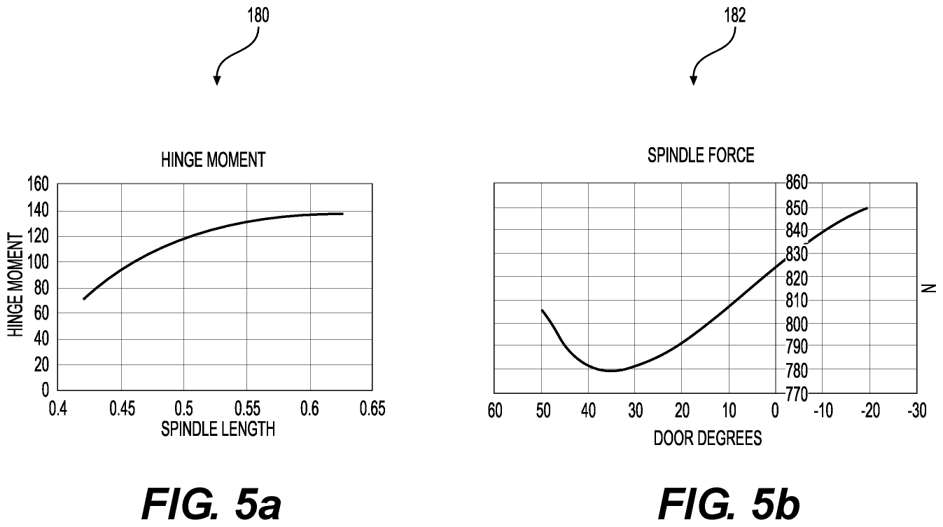

As shown in FIGS. 4,5,6, the counterbalance mechanism 16 implements changes to spring force constant of the primary biasing element 126a, in order to affect (e.g. vary) the degree to which the biasing mechanism 15 biases the closure panel 14 towards the open position (see FIG. 1) during an open operation of the closure panel 14 or 2) inhibits or otherwise holds the closure panel 14 from continuing towards the closed position during a close operation of the closure panel 14. For example, FIG. 5 shows a graph of hinge moment verses spindle (e.g. counterbalance mechanism 16) length for the closure panel 14 (assumed door weight of 20 kg), as well as a graph of corresponding spindle force verses door open degree. It is recognized that the force provided by the counterbalance mechanism 16 (via the biasing mechanism 15) can be shown by example in FIG. 5, such that the door degrees represents the door angle with respect to the horizontal and the force is used to balance the weight of the closure panel 14 over for a respective door degree.

Referring to FIG. 2, the actuator 130 is responsive to the controller 70 signals to move the position of the movable plate 128 along the bias axis 132. As one embodiment of coupling of the actuator 130 to the movable plate 128, the leadscrew 140 is rotated by operation of the actuator 130, such that rotary movement of mating threads 142 between the leadscrew 140 and corresponding threads of the movable plate 128 is transformed into the translation of the moveable plate 128. As further described below, as translation of the movable plate 128 (compresses or alternatively extends) the biasing elements 126a,b, since the axial position of the fixed abutment 124a,b on the bias axis 132 is fixed, the spring constant of the biasing elements 126a,b is adjusted and thus the spring force applied to the closure panel 14 operation is varied. In other words, operation of the actuator 130 causes the relative axial distances D1, D2 between the movable plate 128 and the fixed abutments 124a,b to vary, thus also varying the degree of compression (or extension) of the biasing element(s) 126a,b juxta positioned between the movable plate 128 and their respective fixed abutment 124a,b (e.g. plate, pin, etc.) of the housing 200.

Referring to FIG. 3a, shown is a prior art example of a standard strut 16′ design with a spring S. Referring to FIG. 3b, shown is the counterbalance mechanism 16 shown in an open position and in a closed position. As shown by example, in the open position, the movable plate 128 has been extended along the lead screw 140 towards the primary abutment 124a (as compared to the axial position of the movable plate 128 shown in the closed position), in an effort to augment (i.e. increase) the strength of the primary biasing element 126a.

Referring to FIG. 4, show is the position of the moveable plate 128 in three different axial positions, with respect to the primary abutment 124a, showing three different biasing forces F1, F2, F3 of the primary biasing element 126b. For example, biasing force F2 is the relatively the least when the closure panel 14 is in a between S2 position between the open S3 and closed S1 positions, biasing force F1 is relatively intermediate (comparatively) when the closure panel 14 is at the closed position S1, and biasing force F3 is the relatively the greatest when the closure panel 14 is operated towards the open position S3. For example, position S1 is the starting position of the counterbalance mechanism 16 incorporating the biasing mechanism 15. For example, position S2 is the position of the counterbalance mechanism 16 (incorporating the biasing mechanism 15) corresponding to the minimum required force F2. For example, position S3 is the position of the counterbalance mechanism 16 (incorporating the biasing mechanism 15) when the closure panel 14 is completely open. Also shown is a graph of the force F1, F2, F2 varying by degrees of open of the closure panel 14.

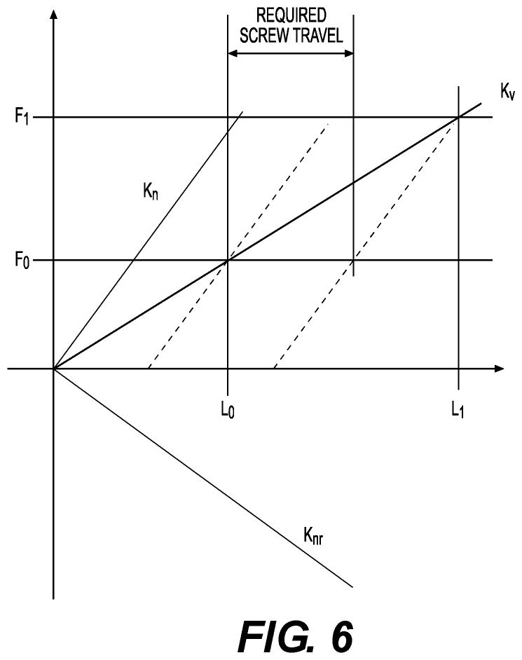

As such, demonstrated by example is how the biasing force F1,F2,F3 (e.g. primary spring force) of the primary biasing element 126a can vary as the moveable plate 128 position on the bias axis 132 (see FIG. 2) changes as the closure panel is moved between the closed position S1 and the open position S3. Referring to FIG. 5, show are example moment vs spindle length graph 180 and spindle force vs. door degrees graph 182 for an example closure panel 14 configuration (e.g. example door weight of 20 kg). Referring to FIG. 6, shown are example variances in the primary spring constant Kn (of the primary biasing element 126a) and the secondary spring constant Knr (of the secondary biasing element 126b) as a function of length Lo, L1 of the counterbalance mechanism 16 (e.g. as the length of the housing 200—see FIG. 1—is extended from Lo to L1 during opening of the closure panel 14). The spring constant Kv refers to the strut 16′ configuration of FIG. 3a. It is noted that the spring constants Kn and Knr are inversely proportional to one another, as primary biasing element 126a can shorten as the secondary biasing element 126b expands during operation of the counterbalance mechanism 16 (e.g. as the moveable plate 128 is varied along the bias axis 132—see FIG. 4 by example). In other words, the change of the primary spring constant Kn is in an opposite direction to the change in the secondary spring constant Knr.

Further, it is recognized that the spindle force for the mechanism shown in FIG. 3a is disadvantageously at a maximum when the spindle is compressed and must assume the proper force when the spindle is elongated, signifying that a higher force is required to start the opening due to the standard kinematics being the two attachment points and hinges near on a straight line with a relatively lower arm for the moment at the starting point. On the contrary, advantageously, the counterbalance mechanism 16 shown in FIG. 3b is such that the position of the closure panel 14 is not fixed from the lead screw (or motor) position due to tolerances of force provided by the two biasing elements 126a,b. In this way, a sensor(s) 76 can be used to sense the position of the closure panel 14, as desired, as the counterbalance mechanism 16 is operated during travel of the closure panel 14.

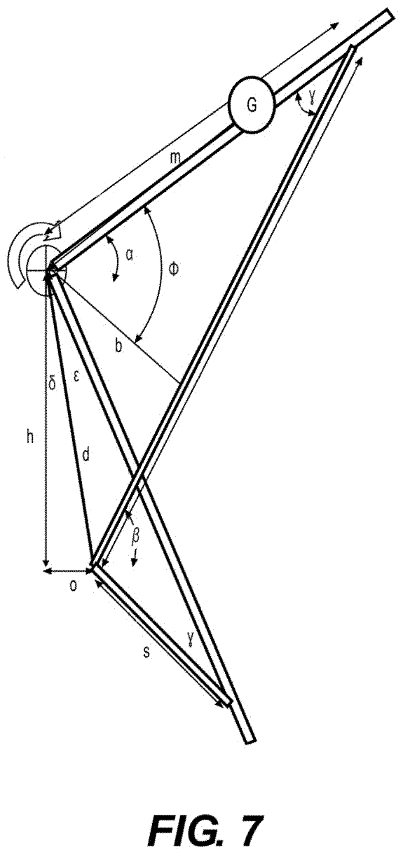

Referring to FIG. 7, shown is an example diagram for a kinematic model of the closure panel 14 (see FIG. 1), as the closure panel 14 moves from the closed position S1 to the open position S3 (see FIG. 4). For example, as per FIG. 7:

| id | Description |
|---|---|
| o | Horizonal distance between the door hinges |
| | and Spindle Hinge on pillar |
| h | Vertical distance between the door hinges |
| | and Spindle Hinge on pillar |
| d | Distance between the door hinges and |
| | Spindle Hinge on pillar |
| δ | Angle between the door hinges and Spindle |
| | Hinge on pillar |
| s | Spindle lenght |
| l | Distance of the Spindle Door attachment |
| | from door hinges |
| ε | Angle of the door with d (line) |
| α | Angle of the door on Horizontal |
| γ | Angle between door and Spindle |
| β | Spindle angle with horizontal |
| ϕ | angle of the Door with Spindle Normal |
| b | Arm |
| M | Door Weight Moment at hinge |
| R | Required Force to Spindle to equlibrate the moment |

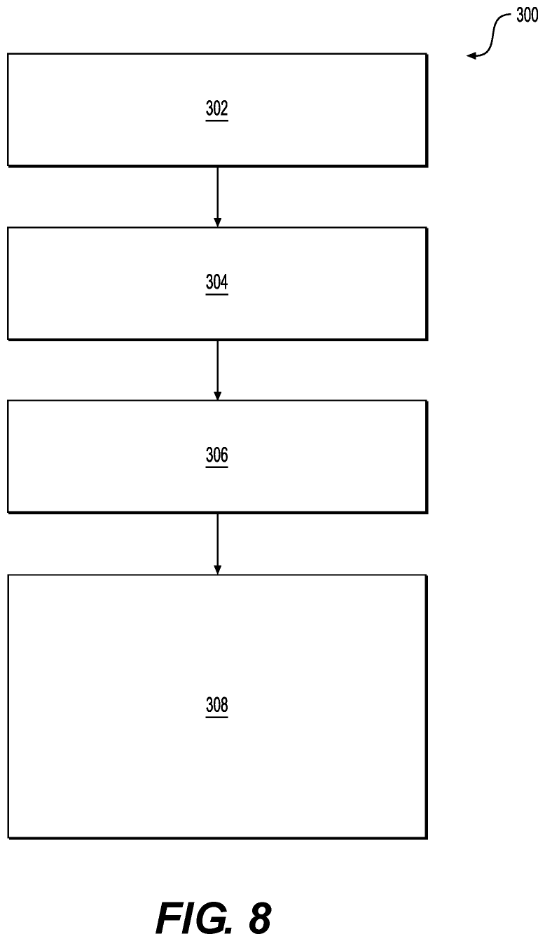

Now referring to FIGS. 1, 2 and 8, there is provided an example method 300 of operating a counterbalance mechanism 16 provided between a closure panel 14 and the vehicle body 11 using a biasing mechanism 15 having a dynamically adjustable spring rate to counteract the torque load of the vehicle closure panel 14 acting on the counterbalance mechanism 16. The method begins at step 302 by determining the angle of inclination of the vehicle 11 relative to a level plane (e.g. ground 6). The method 300 continues with the step 304 of opening or closing the closure panel 14 using an actuator 130 provided between the vehicle body 11 and the closure panel 14. The method 300 continues with the step 306 of sensing the position of the closure panel 14 (e.g. via sensor(s) 76) relative to the vehicle body 11. The method 300 continues with the step 306 of adjusting the spring rate of the spring (e.g. primary biasing element 126a) by compressing or extending the primary biasing element 126a (by movement of the movable plate 128 along the bias axis 132 by rotating the lead screw 140), based on a determined difference between the difference between the angle of inclination of the vehicle 11 on a level surface, and the angle of inclination on a non-level surface so that the force exerted by the counterbalance mechanism 16 on the closure panel 14 counteracts the force of the weight of the closure panel 14 acting on the counterbalance mechanism 16.

We claim:

1. A counterbalance mechanism (16) for assisting in opening and closing of a closure panel (14) of a vehicle (10) between a closed position and an open position, the counterbalance mechanism including:
a housing (200) for mounting a biasing mechanism (15) of the counterbalance mechanism between a body (11) of the vehicle and the closure panel;
the biasing mechanism including:
a fixed primary abutment (124a) of the housing having a primary biasing element (126a) mounted thereon;
a fixed secondary abutment (124b) of the housing having a secondary biasing element (126b) mounted thereon;
a moveable element (128) variably positioned on a bias axis (132) of the housing, the moveable element between the primary biasing element and the secondary biasing element, an axial position of the moveable element movable in relation to the fixed primary abutment and the fixed secondary abutment to selectively change a primary bias of the primary biasing element and a secondary bias of the secondary biasing element; and
an actuator (130) connected to the movable element, the actuator responsive to a control signal (72) in order to adjust the position of the movable element;
wherein the primary biasing element applies a primary spring force to moderate extension of the counterbalance mechanism affecting movement of the closure panel between the open and closed positions.

2. The counterbalance mechanism of claim 1 further comprising a lead screw (140) coupled to the actuator and the movable element, the moveable element being a plate.

3. The counterbalance mechanism of claim 2 further comprising the primary bias is a primary spring constant (Kn) the secondary bias is a secondary spring constant (Knr).

4. The counterbalance mechanism of claim 1, wherein said change of the primary spring constant is in an opposite direction to said change in the secondary spring constant.

5. The counterbalance mechanism of claim 1, wherein the housing (200) including a first tube and a second tube, the first and the second tubes extendable and retractable relative to one another, wherein in response to the actuator responsive adjusting the position of the movable element the first and the second tubes move relative to one another to affect movement of the closure panel between the open and closed positions.

6. The counterbalance mechanism of claim 5, further comprising a position sensor for detecting the relative extension and retraction of the counterbalance mechanism.

7. The counterbalance mechanism of claim 6, further comprising a controller in communication with the actuator and the position sensor, the controller configured to control the actuator in response to the sensor for detecting the relative extension and retraction to affect movement of the closure panel between the open and closed positions.

8. The counterbalance mechanism of claim 1, further comprising a controller in communication with the actuator and the position sensor, the controller configured to control the actuator in response to the sensor for detecting the relative extension and retraction to hold the closure panel in a stopped position between the open and closed positions.

9. The counterbalance mechanism of claim 1, further comprising an angle sensor for detecting incline information to compensate for changes in angle experienced by the biasing mechanism 15.

10. The counterbalance mechanism of claim 1, wherein the primary biasing element is a coil spring.

11. The counterbalance mechanism of claim 1, wherein the secondary biasing element is a coil spring.

12. The counterbalance mechanism of claim 1 further comprising a lead screw (140) coupled to the movable element by a drive nut, such that rotation of the lead screw by the actuator causes said adjust the position of the moveable element.

13. The counterbalance mechanism of claim 12, wherein the movable element is a plate connected to the drive nut.

14. A method of operating the counterbalance mechanism of claim 1 by moving the moveable element between the fixed primary abutment and the fixed secondary abutment in order to vary the primary spring constant of the primary biasing element and the secondary spring constant of the secondary biasing element.

15. The method of claim 14, wherein said change of the primary spring constant is in an opposite direction to said change in the secondary spring constant.

16. The method of claim 14, further comprising using a position sensor to determine one of a movement and a position of the closure panel between the open and closed positions and controlling the actuator in response to determining the one of a movement and a position of the closure panel to effect the movement of the closure panel.

17. The method of claim 14, further comprising using a position sensor to determine one of a movement and a position of the closure panel between the open and closed positions and controlling the actuator in response to determining the one of a movement and a position of the closure panel to effect the holding of the closure panel at a fixed position between the open and closed positions.

18. The method of claim 14, further comprising detecting if the vehicle is positioned on an incline using an angle sensor in order to compensate for changes in weight of the closure panel.

19. A method of operating the counterbalance mechanism comprising:
providing a housing having a first tube coupled to a vehicle body of a vehicle and a second tube coupled to a closure panel of the vehicle, the first tube and the second tube extendable and retractable relative to one another;
providing within the housing a first spring coupled to the vehicle body and a second spring coupled to the closure panel;
providing a moveable element coupling the first spring with the second spring, the moveable element moveable between the vehicle body and the closure panel; and
moving the moveable element in order to vary the primary spring constant of the primary biasing element and the secondary spring constant of the secondary biasing element.

20. The method of claim 19, further comprising detecting if the vehicle is positioned on an incline using an angle sensor in order to compensate for changes in weight of the closure panel.
